(19) United States
(12) Patent Application Publication
(10) Pub. No.: US 2001/0045388 A1
(43) Pub. Date: Nov. 29, 2001

(54) Soup ladle structure

(76) Inventor: Chen-Lung Ho, Tao-Yuan Hsien (TW)

Correspondence Address: Chen-Lung Ho, P.O. Box No. 6-57, Chung-Ho City, Taipei Hsien, 235, TW

(21) Appl. No.: 09/859,595

(22) Filed: May 18, 2001

(30) Foreign Application Priority Data
May 26, 2000 (TW) 089209006

(51) Int. Cl. B01D 29/44

(52) U.S. Cl. 210/470; 210/488

(57) ABSTRACT

A soup ladle structure comprises of a soup ladle having a spoon portion with a perforated strainer pore, an elastic element and a stop straining plate; wherein the elastic element is inserted and axially conjoined to handle bodies of the soup ladle and the stop straining plate by means of an axle pin for always maintaining a cover body covering closely on the strainer pore of the soup ladle, while the press handle on the upper end of the stop straining plate makes the cover plate on the lower end lift to open or close tightly on the strainer pore by the axially engaged point and the elastic element to further achieve the purposes of either straining the liquid while leaving the fat for scooping up and removing the floating fat of the broth or only picking up the solid food.

### BACKGROUND OF THE INVENTION

1) Field of the Invention

The present invention relates to a fat skimming soup ladle, more especially, an improved soup ladle structure scoops up either only the floating fat scum on the surface of the broth or only the solid food without removing the delicious broth.

2) Description of the Prior Art

In today's society, most people live richly and take in excess nutrient so as to cause some cases of obesity, therefore we start to pay more attention to the food and beverage and try to reduce the oil or fat to be consumed into our bodies. The percentage of the fat quantity contained in the broth is usually higher than that in the common delicacies because all the fat contained in the food material will be emulsified into the hot soup and form a layer of floating fat during cooking; to avoid taking in, we often scoop it up and remove it by means of a soup ladle; accordingly, the conventional soup ladles generally available on the market can be categorized approximately into two kinds:

A soup ladle for scooping the soup, the bottom plane of the spoon portion thereof is of either a flat or a recessed arcuate plane; the advantages of the said soup ladle are that it can be used for scooping the soup to drink or for picking up the floating fat scum on the surface of the soup during decocting or stewing the broth. However, the disadvantage of it is that while picking up and removing the floating fat scum, the soup liquid will be picked up together; at this time, the picked soup liquid will be slowly poured back into the soup pot but the floating fat may inevitably flow into the soup pot too, through the inefficient and repeated movements, most of the floating fat scum is then picked up and removed, however, in the mean time, a lot of delicious broth has also been picked up and removed.

A soup ladle capable of straining the soup, the strainer pores are perforated on the bottom plane of the spoon portion thereof; the advantage of the said soup ladle is that it is used exclusively for scooping the solid food inside the soup while the soup liquid flows into the soup pot through the strainer pores; the disadvantage of it is that it is incapable of picking up and removing the floating fat scum.

In view of the various mentioned shortcomings, the inventor of the present invention, devoted mentally and intellectually to research discreetly for overcoming the disadvantages and integrating the advantages, based on experience cumulated from engagement in this industrial field for more than ten years, culminated in the development of the improved soup ladle structure comprising of a soup ladle having a spoon portion with a perforated strainer pore, an elastic element and a stop straining plate; the handle body of the said soup ladle and the handle body of the stop straining plate engage axially to each other, an elastic element is disposed at the engaged area, the said elastic element works onto the stop straining plate to maintain the cover plate thereof always covering closely over the strainer pore, the head end of the said stop straining plate has a press handle and the tail end has a cover plate; the said stop straining plate uses the axially engaged area as a supporting point to enable the head and the tail ends thereof to move up and down on the soup ladle thereby to achieve the effect of straining the liquid while leaving the fat for scooping up and removing the floating fat of the broth.

### SUMMARY OF THE INVENTION

Therefore, the primary objective of the present invention is to design an improved soup ladle, wherein an elastic element is inserted and axially conjoined to the handle bodies of the soup ladle and the stop straining plate by means of an axle pin for always maintaining a cover body covering closely on the strainer pore of the soup ladle, while the press handle on the upper end of the stop straining plate makes the cover plate on the lower end lift to open or close tightly on the strainer pore by the axially engaged point and the elastic element to further achieve the purposes of either straining the liquid while leaving the fat for scooping up and removing the floating fat of the broth or only picking up the solid food.

For achieving the mentioned objectives, the present invention is embodied accordingly that an improved soup ladle structure comprises of a soup ladle having a spoon portion with a perforated strainer pore, an elastic element and a stop straining plate, the handle body of the said soup ladle and the handle body of the stop straining plate engage axially to each other; an elastic element is disposed at the axial engaged area, the said elastic element works onto the stop straining plate to maintain the cover plate thereof always covering closely over the strainer pore; the head end of the said stop straining plate has a press handle and the tail end has a cover plate; the said stop straining plate uses the axially engaged area as a supporting point to enable the head and the tail ends thereof to move up and down on the soup ladle; when the press handle is depressed downward, the cover plate on the other end will raise upward and open the strainer pore; when being released, the press handle recoils back and raises upward to the original position by the recoil force of the elastic element, while the cover plate on the other end lowers down to closely cover on the strainer pore, thereby to achieve the effect of straining the liquid while leaving the fat for scooping up and removing the floating fat of the broth.

To enable a further understanding of the objectives, features and effects of the present invention, the brief description of the drawings below is followed by the detailed description of the preferred embodiment.

### BRIEF DESCRIPTION OF THE DRAWINGS

FIG. 1 is an exploded drawing of the improved soup ladle structure of the present invention.

FIG. 2 is an assembled drawing of the improved soup ladle structure of the present invention.

FIG. 3 is the first reference drawing of the improved soup ladle structure of the present invention in application state.

FIG. 4 is the second reference drawing of the improved soup ladle structure of the present invention in application state.

FIG. 5 is the third reference drawing of the improved soup ladle structure of the present invention in application state.

### DETAILED DESCRIPTION OF THE PREFERRED EMBODIMENTS

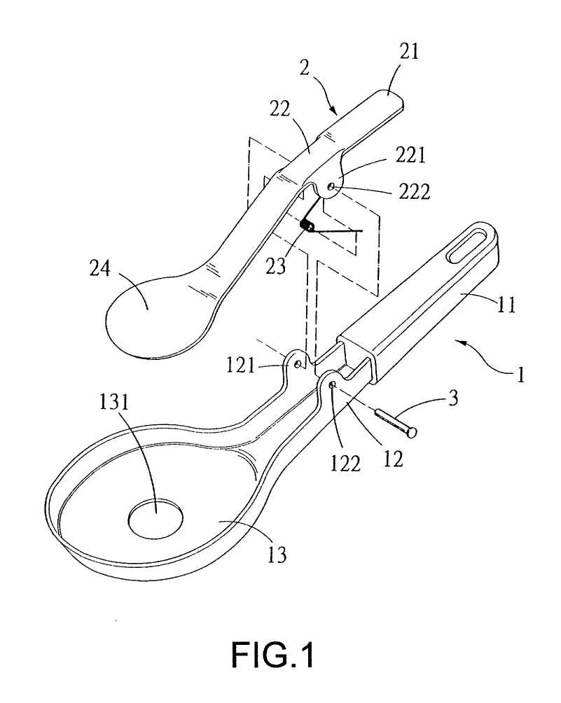

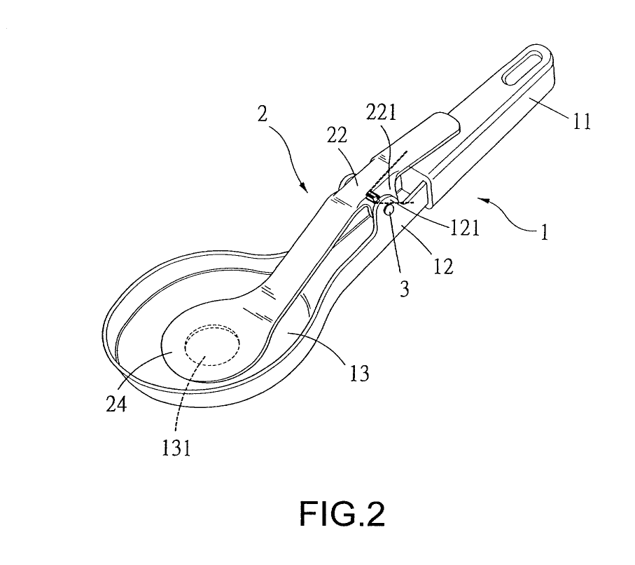

Referring to FIGS. 1 and 2, the exploded drawing and the assembled drawing of the improved soup ladle structure of the present invention, as indicated, the structure comprises of a soup ladle (1) having a straining pore (131) perforated on the spoon portion (13), an elastic element (23) and a stop straining plate (2); the upper end of the said soup ladle (1) is a handle (11) while the lower end is a spoon portion (13); the bottom plane of the spoon portion (13) is a flat bottom with a straining pore (131) perforated at the center, two upward and upstanding fixed pieces (121) are disposed respectively on the two sides of the handle body (12) intervened between those two portions, an axle hole (122) is mounted respectively and correspondingly on each of the two fixed pieces (121); the said elastic element (23) is a torsion spring that works between the stop straining plate (2) and the soup ladle (1), and presses upward against the rear plane of the press handle (21) through the recoil force thereof; when the press handle (21) is depressed downward, the torsion spring is also under pressure but the recoil force is augmented, therefore, when the press handle (21) is released, the recoil force will again press upward against the press handle (21) and make the cover plate (24) always closely cover on the strainer pore (131); the said stop straining plate (2) is in a bent form, the upper end thereof is a press handle (21) and the lower end is a cover plate (24); the plate plane shape of the said cover plate (24) corresponds to the bottom plane of the spoon portion (13) of the soup ladle (1), the plate plane of the cover plate (24) is a little larger than the strainer pore (131) on the bottom plane of the spoon portion (13); two downward and upstanding fixed pieces (221) are disposed respectively on the two sides of the handle body (22), an axle hole (222) is mounted respectively and correspondingly on each of the two fixed pieces (221), the elastic element (23) is disposed between the two fixed pieces (221); then the two fixed pieces (221) of the stop straining plate (2) are mounted to be engaged between the two fixed pieces (121) of the soup ladle (1) and inserted to the corresponding axle holes (122, 222) and the elastic element (23) through the axle pin (3), so as to engage the stop straining plate (2) axially and fixedly onto the soup ladle (1); after accomplishing the assembly, the two ends of the stop straining plate (2) use the axially connected point as a supporting point, the elastic element (23) uses its recoil force to press upward against the rear plane of the press handle (21), therefore, the cover plate (24) is depressed downward to closely cover over the strainer pore (131).

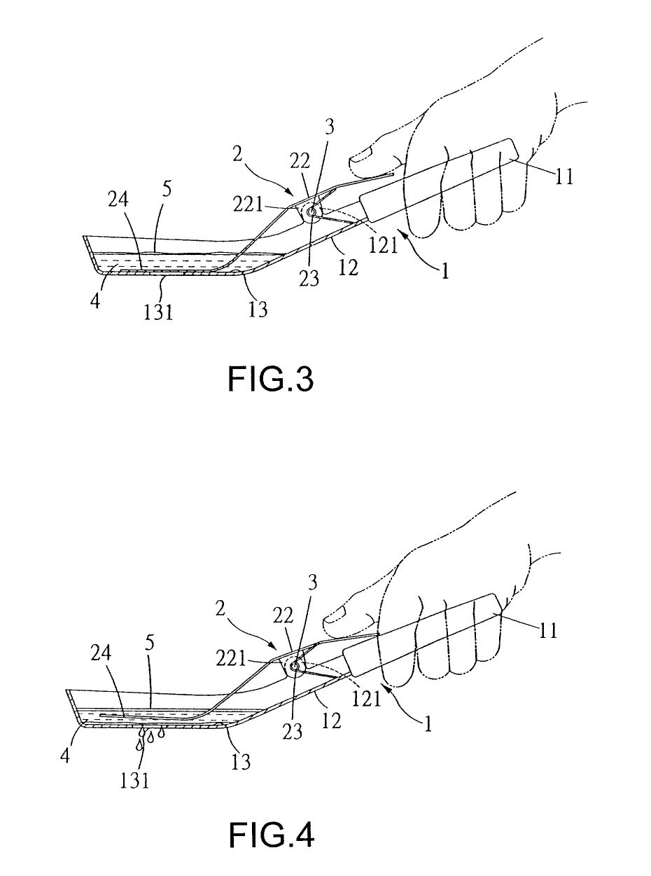

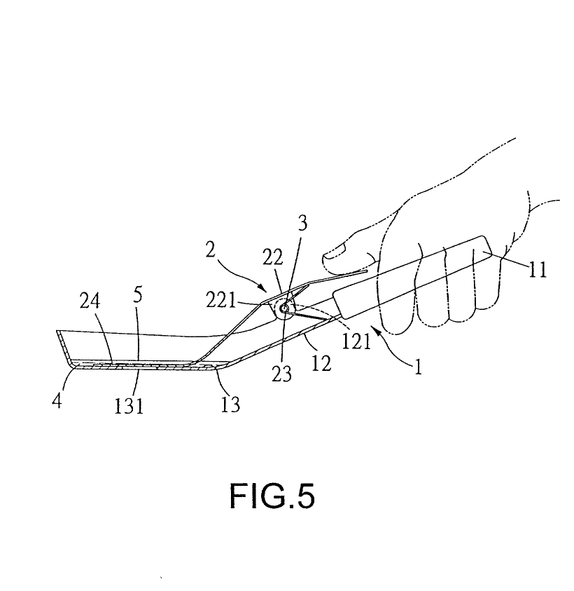

Referring to FIGS. 3, 4 and 5, the first, the second and the third reference drawings of the improved soup ladle structure of the present invention in application state, as indicated, the palm holds the handle (11) of the soup ladle (1), the thumb gently presses on press the handle (21) of the stop straining plate (2) to scoop up the floating fat (5) in the soup pot; after scooping up, the soup liquid (4) and a layer of fat (5) floating thereon are left inside the spoon portion (13) of the soup ladle (1); the thumb depresses down the press handle (21) on one end of the stop straining plate (2) to make the cover plate (24) on the other end lift up, at this time, the soup ladle (1) is slowly picked up from the soup, the soup liquid (4) with heavier specific gravity will flow back into the pot through the strainer pore (131) on the spoon portion (13) and the water level inside the spoon portion (13) will slowly descend; when the bottom plane of the spoon portion (13) of the soup ladle (1) evenly contacts the surface of the soup, the fat (5) floating on the surface and with lighter specific gravity can not flow downward, in the mean time, the thumb releases the press handle (21), the press handle (21) utilizes the recoil force of the elastic element (23) to raise upward while the cover plate (24) on the other end of the stop straining plat (2) presses downward to cover closely over the strainer pore (131) of the spoon portion (13) to prevent the floating fat (5) from flowing back into the pot, then the soup ladle (1) is moved to the outside of the soup pot and the floating fat (5) inside the spoon portion (13) is poured into other container to finish the work, thereby the floating fat (5) inside the soup pot will be scooped up and removed gradually and completely.

In summation of the foregoing sections, the present invention is more structurally innovative and has more advantages than the conventional soup ladle, possesses advancement and improvement, complies with all new patent application requirements and is hereby lawfully submitted to the patent bureau for review and the granting of the commensurate patent rights.

Although the present invention has been disclosed by a preferred embodiment hereinbefore, it should not be construed as a limitation on the embodiment scope of the present invention. It is apparent to those skilled in the art that many variations or modifications to be achieved easily will not separate from the spirit of the present invention. The scope of the claims applied for new patent rights also try to include all the variations or modifications within the spiritual scope defined in the present invention.

1. A soup ladle structure comprising a soup ladle having a spoon portion with a perforated strainer pore and an elastic element is characterized that:
the handle body of the said soup ladle and the handle body of the stop straining plate engage axially to each other, an elastic element is disposed at the said axially engaged area, the said elastic element works onto the stop straining plate to maintain the cover plate thereof always covering closely over the strainer pore;
the head end of the said stop straining plate has a press handle and the tail end has a cover plate; the said stop straining plate uses the said axially engaged area as a supporting point to enable the head and the tail ends thereof to move up and down on the soup ladle; when the press handle is depressed downward, the cover plate on the other end will raise upward and open the strainer pore; when being released, the press handle recoils back and raises upward to the original position by the recoil force of the elastic element, while the cover plate on the other end lowers down to closely cover on the strainer pore, thereby to further achieve the effect of straining the liquid while leaving the fat for scooping up and removing the floating fat of the broth.

2. The soup ladle structure of claim 1, wherein, the number of the said strainer pore can be plural.

3. The soup ladle structure of claim 1, wherein, a upstanding fixed piece can be disposed respectively on the two sides of the handle bodies of the said soup ladle and the stop straining plate, furthermore, on the fixed pieces, there are axle holes communicated with each other and inserted by a axle pin to make a movable axial engagement.

4. The soup ladle structure of claim 1, wherein, the shape of the plate plane of the said cover plate corresponds to the top plane of the spoon portion.

5. The soup ladle structure of claim 1, wherein, the said elastic element is disposed between the two fixed pieces of the stop straining plate.
